(19) United States
(12) Patent Application Publication
(10) Pub. No.: US 2020/0103699 A1
(43) Pub. Date: Apr. 2, 2020

(54) COLOR FILTER AND LIQUID CRYSTAL PANEL

(71) Applicants: HKC Corporation Limited, Shenzhen (CN); Chongqing HKC Optoelectronics Technology Co., Ltd., Chongqing (CN)

(72) Inventor: Zhongnian Liu, Shenzhen (CN)

(21) Appl. No.: 16/257,082

(22) Filed: Jan. 25, 2019

Related U.S. Application Data
(63) Continuation of application No. PCT/CN2018/114623, filed on Nov. 8, 2018.

(30) Foreign Application Priority Data
Sep. 30, 2018 (CN) 201811157048.8

(51) Int. Cl. G02F 1/1335; G02F 1/1339; G02B 5/20

(52) U.S. Cl. CPC G02F 1/133514; G02B 5/201; G02F 1/133512; G02F 1/13394

(57) ABSTRACT

The invention discloses a color filter and a liquid crystal panel, wherein the color filter comprises three spacers, a first spacer is defined on the surface of a first photoresist layer, a second spacer and a third spacer are defined above a black matrix, and the first spacer is higher than the second spacer and the third spacer.

### CROSS REFERENCE TO RELATED APPLICATIONS

The present application is a Continuation Application of PCT Application No. PCT/CN2018/114623 filed on Nov. 8, 2018, which claims the benefit of Chinese Patent Application No. 201811157048.8 filed on Sep. 30, 2018. All the above are hereby incorporated by reference.

### FIELD

The present disclosure relates to the field of liquid crystal display technology, and in particular, relates to a color filter and a display panel using the color filter.

### BACKGROUND

Liquid crystal panels of liquid crystal displays includes a thin film transmitter, a liquid crystal layer, and a color filter. A plurality of spacers supporting the liquid crystal cell are also defined between the color filter and the array substrate to ensure the cell thickness of the liquid crystal cell. Further, in order to ensure that the liquid crystal cell has enough liquid crystal redundancy to resist the influence of temperature change and pressure change on the liquid crystal cell, a part of several spacers may be defined as the main spacers when designing the liquid crystal panel, and the other part of several spacers may be defined as auxiliary spacers, and it is necessary to ensure sufficient segment differences between the main spacers and the auxiliary spacers. At present, the segment difference between the main spacer and the auxiliary spacer is generally formed by laying a pad layer only under a part of spacers, so that this part of spacers is higher than another part of the spacers and becomes the main spacer. However, the structure and manufacturing process of the color filter obtained in this way are complicated and costly.

### SUMMARY

The main purpose of the present disclosure is to provide a color filter, aiming at simplifying the structure and manufacturing process of the color filter.

In order to achieve the above object, the color filter proposed in the present disclosure includes:

base;

a black matrix, defined on one plate surface of the base, the black matrix defining a first filling area, a second filling area and a third filling area at intervals;

a color filter layer, including a first photoresist layer, a second photoresist layer, and a third photoresist layer, the first photoresist layer is filled in the first filling area, the second photoresist layer is filled in the second filling area, the third photoresist layer is filled in the third filling area, and the edge of the first photoresist layer extends outside the first filling area and overlaps the surface of the black matrix away from the base; and

and a spacer, including a first spacer, a second spacer and a third spacer, the first spacer is defined on the surface of the first photoresist layer overlapping the black matrix, the second spacer and the third spacer are defined above the black matrix, the surface of a free end of the first spacer is higher than the surface of a free end of the second spacer, the surface of a free end of the first spacer is higher than the surface of a free end of the third spacer.

Optionally, the second spacer and the third spacer are both defined on the surface of the black matrix away from the base.

Optionally, the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix.

Optionally, the edge of the second photoresist layer extends outside the second filling area and overlaps the surface of the black matrix away from the base; the surface of the second photoresist layer overlapping a surface of the black matrix recesses to form a first receiving groove, and the second spacer is defined in the first receiving groove;

and the edge of the third photoresist layer extends outside the third filling area and overlaps the surface of the black matrix away from the base; the surface of the third photoresist layer overlapping the black matrix recesses to form a second receiving groove, and the third spacer is defined in the second receiving groove.

Optionally, the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix;

the second photoresist layer comprises a second overlapping portion located at one end thereof, the second overlapping portion is located outside the second filling area and overlaps the surface of the black matrix away from the base, the surface of the second overlapping portion away from the black matrix recesses to form a first receiving groove,

the third photoresist layer comprises a third overlapping portion located at one end thereof, the third overlapping portion is located outside the third filling area and overlaps the surface of the black matrix away from the base, the surface of the third overlapping portion away from the black matrix recesses to form a second receiving groove.

Optionally, the surface of the black matrix adjacent to the second filling area recesses to form a first receiving groove, the edge of the second photoresist layer extends toward the first receiving groove and is at least partially accommodated in the first receiving groove, and the second spacer is defined on the surface of the second photoresist layer accommodated in the first receiving groove;

the surface of the black matrix adjacent to the third filling area recesses to form a second receiving groove, the edge of the third photoresist layer extends toward the second receiving groove and is at least partially accommodated in the second receiving groove, and the third spacer is defined on the surface of the third photoresist layer accommodated in the second receiving groove.

Optionally, the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix;

the second photoresist layer comprises a second overlapping portion located at one end thereof, the second overlapping portion is defined outside the second filling area and partially accommodated in the first receiving groove, and the second spacer is defined on the surface of the second overlapping portion accommodated in the first receiving groove;

the third photoresist layer comprises a third overlapping portion located at one end thereof, the third overlapping portion is defined outside the third filling area and partially accommodated in the second receiving groove, and the third spacer is defined on the surface of the third overlapping portion accommodated in the second receiving groove,

Optionally, the thickness of the first photoresist layer is greater than the thickness of the second photoresist layer. the thickness of the first photoresist layer is greater than the thickness of the third photoresist layer, the thickness of the second photoresist layer is equal to the thickness of the third photoresist layer.

Optionally, the first photoresist layer, the second photoresist layer and the third photoresist layer are respectively a blue photoresist layer, a green photoresist layer, and a red photoresist layer.

According to the technical schemes of the present disclosure, by extending the edge of the first photoresist layer outside the first filling area and overlapping the edge of the first photoresist on the surface of the black matrix away from the substrate while the first spacer is defined on the surface of the first photoresist layer overlapping the black matrix and the free end surfaces of the second and third spacers are made lower than the free end surface of the first spacer, the height of the first spacer on the surface of the first photoresist layer may be made higher than the height of the second spacer, as well as the height of the third spacer. Thus the first spacer becomes the main spacer and forms a sufficient segment difference with the rest auxiliary spacers, i.e., the second spacer and the third spacer, thereby satisfying the liquid crystal redundancy requirement.

Moreover, in the technical schemes of the present disclosure, since the first spacer is formed on the surface of the first photoresist away from the black matrix, the pad layer used to pad the first spacer is the first photoresist layer. In this condition, the pad layer for padding the first spacer may be molded together in the photolithography molding process of the first photoresist layer. Compared with the technical schemes requiring separate padding, the structure and manufacturing process of the color filter of the present disclosure are simpler, more convenient, more stable and more reliable, and the structure and manufacturing process of the color filter may be effectively simplified.

### BRIEF DESCRIPTION OF THE DRAWINGS

In order to more clearly explain the embodiments of the present disclosure or the technical solutions in the prior art, the drawings that need to be used in the embodiments or the description of the prior art will be briefly introduced below. obviously, the drawings in the following description are only some embodiments of the present disclosure. for those of ordinary skill in the art, other drawings maybe obtained according to the structures shown in these drawings without paying creative labor.

FIG. 1 is a schematic structural diagram of a color filter in some embodiments of the present disclosure;

FIG. 2 is a top view of the color filter of FIG. 1;

FIG. 3 is a schematic structural diagram of the color filter of FIG. 1 with grooves in the first photoresist layer;

FIG. 4 is a schematic structural diagram of a color filter in another embodiment of the present disclosure;

FIG. 5 is a schematic structural diagram of a color filter in still another embodiment of the present disclosure;

FIG. 6 is a schematic structural diagram of the color filter of FIG. 5 after removal of the second photoresist layer, the third photoresist layer, the second spacer, and the third spacer.

### BRIEF DESCRIPTION OF THE DRAWINGS

TABLE 1

| Label | Name |
|---|---|
| 100 | Color filter |
| 10 | base |
| 20 | black matrix |
| 21 | first receiving groove |
| 23 | the second receiving groove |
| 30 | first photoresist layer |
| 31 | groove |
| 40 | second photoresist layer |
| 41 | first receiving groove |
| 50 | third photoresist layer |
| 51 | the second receiving groove |
| 60 | the first spacer |
| 70 | the second spacer |
| 80 | third spacer |

The realization, functional features and advantages of the purpose of the present disclosure will be further described with reference to the accompanying drawings in conjunction with the embodiments.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

It should be noted that all directional indications (such as up, down, left, right, front, back) is only used to explain the relative positional relationship between the components in a certain posture (as shown in the figure), and if the specific posture changes, the directional indication changes accordingly.

In addition, in the present disclosure, the descriptions such as “first” and “second” are set for the purpose of description only, and are not to be understood as indicating or implying its relative importance or implicitly indicating the number of indicated technical features. Thus, features defining “first” and “second” may explicitly or implicitly include at least one such feature. In the description of the present disclosure, “plurality” means at least two, e.g., two, three, etc., unless expressly and specifically defined otherwise.

In the present disclosure, unless otherwise expressly specified and defined, the terms “connect”, “fix” and the like shall be understood in a broad sense, for example, “fix” may be a fixed connection, a detachable connection, or an integral body; It can be a mechanical connection or an electrical connection. It can be directly connected or indirectly connected through an intermediate medium. It can be the internal communication of two elements or the interaction relationship between two elements, unless otherwise explicitly defined. For those of ordinary skill in the art, the specific meaning of the above terms in the present disclosure can be understood according to the specific circumstances.

In addition, the technical solutions between the various embodiments according to the present disclosure may be combined with each other, but must be based on what one of ordinary skill in the art can achieve. When the combination of technical solutions is contradictory or impossible to achieve, it should be considered that the combination of such technical solutions does not exist and is not within the scope of protection required by the present disclosure.

The present disclosure proposes a color filter 100, which is applied to a liquid crystal panel and aims to simplify the structure and manufacturing process of the color filter 100.

The specific structure of the color filter 100 will be described below.

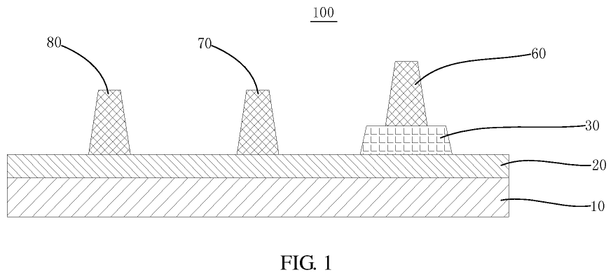

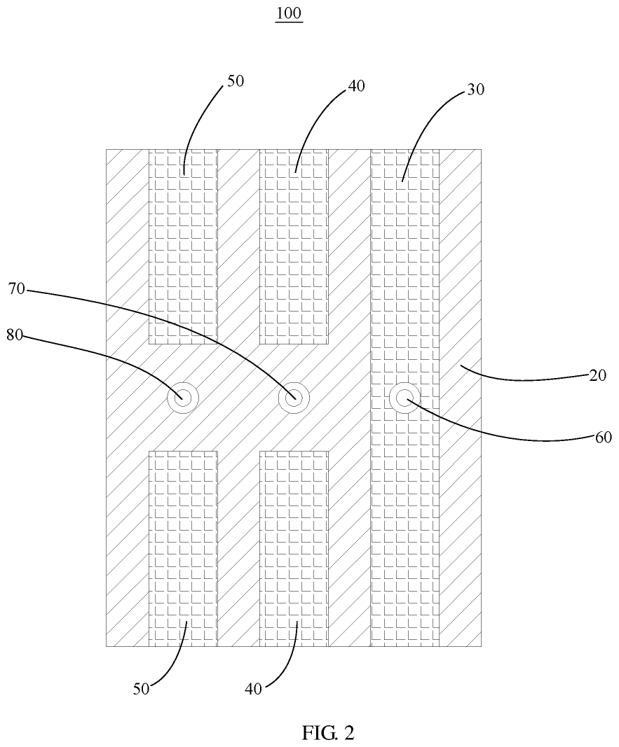

As shown in FIGS. 1 and 2, in some embodiments of the color filter 100 of the present disclosure, the color filter 100 includes:

a base 10,

a black matrix 20, defined on one plate surface of the base 10, the black matrix 20 defining a first filling area, a second filling area and a third filling area at intervals;

a color filter layer, including a first photoresist layer 30, a second photoresist layer 40, and a third photoresist layer 50, the first photoresist layer 30 is filled in the first filling area, the second photoresist layer 40 is filled in the second filling area, the third photoresist layer 50 is filled in the third filling area, and the edge of the first photoresist layer 30 extends outside the first filling area and overlaps the surface of the black matrix 20 away from the base 10; and

a spacer, including a first spacer 60, a second spacer 70 and a third spacer 80, the first spacer 60 is defined on the surface of the first photoresist layer 30 overlapping the black matrix 20, the second spacer 70 and the third spacer 80 are defined above the black matrix 20, the surface of a free end of the first spacer 60 is higher than the surface of a free end of the second spacer 70, the surface of a free end of the first spacer 60 is higher than the surface of a free end of the third spacer 80.

Specifically, the second spacer 70 may be formed either directly on the upper surface of the black matrix 20 or on the surface of the second color resist layer 40 located outside the second filling area and overlapped on the black matrix 20. The third spacer 80 may be formed directly on the upper surface of the black matrix 20 or may be formed on the surface of the third color resist layer 50 outside the third filling area and overlapped on the black matrix 20. Moreover, if the second spacer 70 is formed outside the second filling area of the second photoresist layer 40 and is overlapped on the surface of the black matrix 20, the thickness of the second photoresist layer 40 is lower than that of the first photoresist layer 30. If the third spacer 80 is formed on the surface of the third photoresist layer 50 outside the third filling area and overlapped on the black matrix 20, the thickness of the third photoresist layer 50 is lower than that of the first photoresist layer 30. In this way, the height of the spacer formed on the first photoresist layer 30 will be higher than the height of the spacer formed on the black matrix 20 and on the second and third photoresist layers 50 after the processes of coating, exposure and development, thus forming a sufficient segment difference between the main spacer and the rest auxiliary spacer to meet the liquid crystal redundancy requirement. For example, in this embodiment, the first spacer 60 is the main spacer and the second and third spacers 80 are the auxiliary spacers.

That is, according to the technical schemes of the present disclosure, by extending the edge of the first photoresist layer 30 outside the first filling area and overlapping the edge of the first photoresist on the surface of the black matrix 20 away from the base 10, while the first spacer 60 is defined on the surface of the first photoresist layer 30 overlapping the black matrix 20 and the free end surfaces of the second and third spacers 80 are made lower than the free end surface of the first spacer 60, the height of the first spacer 60 on the surface of the first photoresist layer 30 may be made higher than the height of the second spacer 70, as well as the height of the third spacer 80, thus the first spacer 60 becomes the main spacer and forms a sufficient segment difference with the rest auxiliary spacers, i.e., the second spacer 70 and the third spacer 80, thereby satisfying the liquid crystal redundancy requirement.

Moreover, in the technical schemes of the present disclosure, since the first spacer 60 is formed on the surface of the first photoresist 30 away from the black matrix 20, the pad layer used to pad the first spacer 60 is the first photoresist layer 30. In this condition, the pad layer for padding the first spacer 60 may be molded together in the photolithography molding process of the first photoresist layer 30. Compared with the technical schemes requiring separate padding, the structure and manufacturing process of the color filter 100 of the present disclosure are simpler, more convenient, more stable and more reliable, and the structure and manufacturing process of the color filter may be effectively simplified.

In addition, it should be noted that in this embodiment, the first photoresist layer 30, the second photoresist layer 40, and the third photoresist layer 50 are respectively a blue photoresist layer, a green photoresist layer, and a red photoresist layer. As may be understood, the technical schemes of the present disclosure aims to simplify the structure and manufacturing process of the color filter 100 while ensuring that the segment difference between the main spacer and the auxiliary spacer meets the liquid crystal redundancy requirements, but does not limit the colors of the first photoresist layer 30, the second photoresist layer 40, and the third photoresist layer 50, that is, in other embodiments, the first photoresist layer 30, the second photoresist layer 40, and the third photoresist layer 50 may also be photoresist layers of other colors, so that the liquid crystal panel applying the color filter 100 of the present disclosure may meet other different display requirements. That is, it is also within the scope of the present disclosure that the first photoresist layer 30, the second photoresist layer 40, and the third photoresist layer 50 are different combinations of blue photoresist layer, green photoresist layer, and red photoresist layer, respectively.

As shown in FIGS. 1 and 2, in some embodiments of the color filter 100 of the present disclosure, the second spacer 70 and the third spacer 80 are both defined on the surface of the black matrix 20 away from the base 10.

In this condition, the thickness of the first photoresist layer 30 may bring about the height difference between the first spacer 60 and the second spacer 70, and between the first spacer 60 and the third spacer 80, that is, the segment difference between the main spacer and the auxiliary spacer, thereby satisfying the liquid crystal redundancy requirement. The following description takes the first spacer 60 as the main spacer, the second spacer 70 and the third spacer 80 as the auxiliary spacer, and the first photoresist layer 30, the second photoresist layer 40, and the third photoresist layer 50 are respectively a blue photoresist layer, a green photoresist layer, and a red photoresist layer as examples.

In this embodiment, the second spacer 70 (the auxiliary spacer) is defined on the black matrix 20 between two adjacent green pixel regions (the second filling area), the third spacer 80 (the auxiliary spacer) is defined on the black matrix 20 between two adjacent red pixel regions (the third filling area), and the first spacer 60 (the main spacer) is defined on the blue photoresist layer (the first photoresist layer 30) between two adjacent blue pixel regions (the first filling area). In this condition, the second photoresist layer 40 (green photoresist layer) is of an isolated type, i.e., the second photoresist layer 40 exists only in the green pixel region (second filling area), and there is no photoresist between the upper and lower adjacent green pixel regions; The third photoresist layer 50 (red photoresist layer) is of an isolated type, i.e., the third photoresist layer 50 exists only in the red pixel region (third filling area), and there is no photoresist between the upper and lower adjacent red pixel regions; The first photoresist layer 30 (blue photoresist layer) is of a strip type, the first photoresist layer 30 is a continuous strip shape, and the upper and lower direction is a whole blue photoresist layer. In this condition, there is a difference between the first spacer 60 and the second spacer 70 (and the third spacer 80) due to the thickness of the blue photoresist layer, so that the liquid crystal redundancy of the liquid crystal cell may be improved.

In addition, it should be noted that in the above embodiment, if the thickness of the blue photoresist layer is too large, the difference between the first spacer 60 and the second spacer 70 (and the third spacer 80) is too large, that is, the difference between the main spacer and the auxiliary spacer is too large. In this condition, if the external temperature drops or the liquid crystal panel is pressed, the liquid crystal volume will shrink and the main spacer will be further compressed, but the auxiliary spacer will not contact the array substrate and will not play a supporting role due to too large a segment difference. Therefore, it is necessary to adjust the thickness of the blue photoresist layer at the bottom of the main spacer.

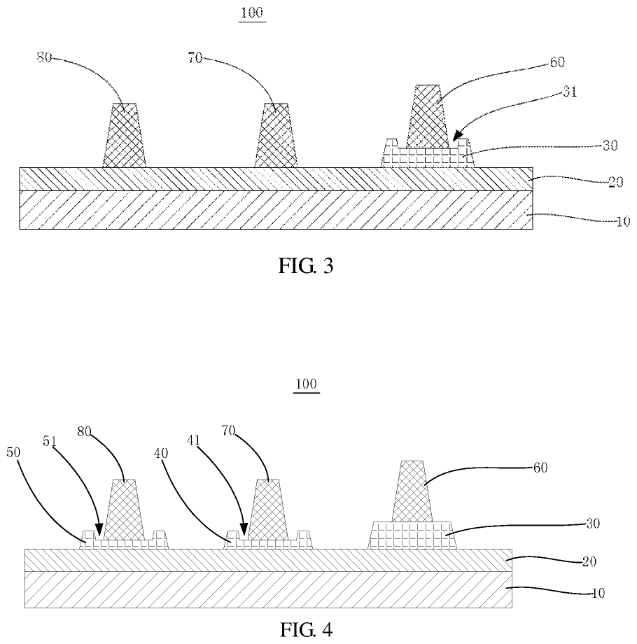

Therefore, the following modified example is proposed. as shown in FIG. 3, the blue photoresist layer is formed by halftone—mask technique, and a semi-transparent mask is used above the blue photoresist layer for supporting the first spacer 60. in this case, the light intensity received by the area under the semi-transparent mask is lower than the surrounding area, and the thickness after forming is thinner, thus groove 31 may be formed on the surface of the blue photoresist layer. In this condition, the first spacer 60 is defined in the groove 31, which may reduce the segment difference between the main spacer and the auxiliary spacer, and may adjust the depth of the groove 31 by controlling the light transmittance of the semi-transparent mask, thereby reasonably adjusting the segment difference.

As shown in FIGS. 1 and 2, in some embodiments of the color filter 100 of the present disclosure, the first color resist layer 30, the second color resist layer 40, and the third color resist layer 50 are all defined in a strip shape, the first color resist layer 30 includes a first overlapping portion located at one end thereof, the first overlapping portion is located outside the first filling area and overlaps the surface of the black matrix 20 away from the base 10, and the first spacer 60 is located on the surface of the first overlapping portion away from the black matrix 20.

Correspondingly, the first filling area, the second filling area and the third filling area are also defined in strips, and in the two adjacent pixels above and below, the two first filling areas are defined in strips along the vertical direction, and the arrangement of the second filling area and the third filling area is similar to the arrangement of the first filling area, which will not be described in detail here. In this condition, the second photoresist layer 40 (green photoresist layer) is of an isolated type, i.e., the second photoresist layer 40 exists only in the green pixel region (second filling area), and there is no photoresist between the upper and lower adjacent green pixel regions; The third photoresist layer 50 (red photoresist layer) is of an isolated type, i.e., the third photoresist layer 50 exists only in the red pixel region (third filling area), and there is no photoresist between the upper and lower adjacent red pixel regions; The first photoresist layer 30 (blue photoresist layer) is of a stripe type, and the first photoresist layer 30 is of a continuous strip shape with an entire blue photoresist layer in the up and down direction.

In this way, the first photoresist layer 30 may be made to be of a stripe type. In this condition, the first photoresist layer 30 may be formed into an entire photoresist layer in the up-down direction at one time, which may further simplify the structure and manufacturing process of the color filter 100.

As shown in FIG. 4, in some embodiments of the color filter 100 of the present disclosure, the edge of the second photoresist layer 40 extends outward of the second filling area and overlaps the surface of the black matrix 20 away from the base 10, the second photoresist layer 40 overlaps the surface of the black matrix 20 and is recessed to form a first receiving groove 41, and the second spacer 70 is defined in the first receiving groove 41;

the edge of the third color resist layer 50 extends outside the third filling area and overlaps the surface of the black matrix 20 away from the base 10, and the overlap of the third color resist layer 50 overlaps the surface of the black matrix 20, recessing to form a second receiving groove 51, and the third spacer 80 is defined in the second receiving groove 51.

The following description takes the first spacer 60 as the main spacer, the second spacer 70 and the third spacer 80 as the auxiliary spacer, and the first photoresist layer 30, the second photoresist layer 40, and the third photoresist layer 50 are respectively a blue photoresist layer, a green photoresist layer, and a red photoresist layer as examples.

In this embodiment, the first spacer 60 (main spacer) is defined on the blue photoresist layer (first photoresist layer 30) between two adjacent blue pixel regions (first filling area); The second spacer 70 (auxiliary spacer) is defined on the green photoresist layer (second photoresist layer 40) between two adjacent green pixel regions (second filling area); the third spacer 80 (the auxiliary spacer) is defined on the red photoresist layer (the third photoresist layer 50) between two adjacent red pixel regions (the third filling area). In this condition, the first photoresist layer 30 (blue photoresist layer), the second photoresist layer 40 (green photoresist layer), and the third photoresist layer 50 (red photoresist layer) are all continuous (stripe type), each photoresist layer is a continuous strip shape, and the upper and lower direction is a whole photoresist layer. Further, the surface of the green photoresist layer (the second photoresist layer 40) between two adjacent green pixel regions (the second filling area) is defined with a first receiving groove 41, and the second spacer 70 (the auxiliary spacer) is defined in the first receiving groove 41. The surface of the red photoresist layer (the third photoresist layer 50) between two adjacent red pixel regions (the third filling area) is defined with a second receiving groove 51 in which the third spacer 80 (the auxiliary spacer) is defined.

In this condition, the thickness of the first color resist layer 30 is greater than the thickness of the second color resist layer 40, and the difference in thickness between the two plusing the depth of the first receiving groove 41 may bring about the difference in height between the first spacer 60 and the second spacer 70; In this condition, the thickness of the first color resist layer 30 is greater than the thickness of the third color resist layer 50, and the difference between the thickness of the first color resist layer 30 and the thickness of the third color resist layer 50, plusing the depth of the second receiving groove 51, may bring about the difference in height between the first spacer 60 and the third spacer 80, which may bring about the segment difference between the main spacer and the auxiliary spacer, thereby satisfying the liquid crystal redundancy requirement.

Therefore, it may be understood that the arrangement of the first receiving groove 41 and the second receiving groove 51 may play a role in improving the interval difference between the main spacer and the auxiliary spacer and ensuring liquid crystal redundancy.

Further, the first photoresist layer 30, the second photoresist layer 40, and the third photoresist layer 50 are all defined in a strip shape, and the first photoresist layer 30 includes a first overlapping portion located at one end thereof, the first overlapping portion is located outside the first filling area and overlaps the surface of the black matrix 20 away from the base 10, and the first spacer 60 is located on the surface of the first overlapping portion away from the black matrix 20;

The second color resist layer 40 includes a second overlapping portion located at one end thereof, the second overlapping portion is located outside the second filling area and overlaps the surface of the black matrix 20 away from the base 10, and the surface of the second overlapping portion away from the black matrix 20 is recessed to form the first receiving groove 41;

the third color resist layer 50 includes a third overlapping portion located at one end thereof, the third overlapping portion is located outside the third filling area and overlaps the surface of the black matrix 20 away from the base 10, and the surface of the third overlapping portion away from the black matrix 20 is recessed to form the second receiving groove 51.

Correspondingly, the first filling area, the second filling area and the third filling area are also defined in strips, and in the two adjacent pixels above and below, the two first filling areas are defined in strips along the vertical direction, and the arrangement of the second filling area and the third filling area is similar to the arrangement of the first filling area, which will not be described in detail here. In this condition, the first photoresist layer 30 (blue photoresist layer), the second photoresist layer 40 (green photoresist layer), and the third photoresist layer 50 (red photoresist layer) are all continuous (stripe type), each photoresist layer is a continuous strip shape, and the upper and lower direction is a whole photoresist layer.

In this way, each photoresist layer may be made to be of a stripe type, and at this time, each photoresist layer may be formed into an entire photoresist layer in the up-down direction at one time, thereby further simplifying the structure and manufacturing process of the color filter 100.

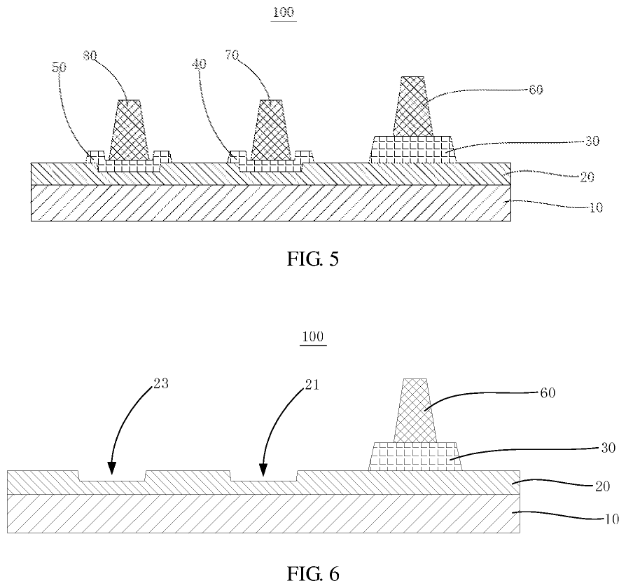

As shown in FIG. 5 and FIG. 6, in some embodiments of the color filter 100 of the present disclosure, the surface of the black matrix 20 adjacent to the second filling area is recessed to form a first receiving groove 21, the edge of the second photoresist layer 40 extends toward the first receiving groove 21 and is at least partially accommodated in the first receiving groove 21, and the second spacer 70 is defined on the surface of the second photoresist layer 40 trapped in the first receiving groove 21;

The surface of the black matrix 20 adjacent to the third filling area is recessed to form a second receiving groove 23, the edge of the third photoresist layer 50 extends toward the second receiving groove 23 and is at least partially accommodated in the second receiving groove 23, and the third spacer 80 is defined on the surface of the third photoresist layer 50 accommodated in the second receiving groove 23.

The following description takes the first spacer 60 as the main spacer, the second spacer 70 and the third spacer 80 as the auxiliary spacer, and the first photoresist layer 30, the second photoresist layer 40, and the third photoresist layer 50 are respectively a blue photoresist layer, a green photoresist layer, and a red photoresist layer as examples.

In this embodiment, the first spacer 60 (main spacer) is defined on the blue photoresist layer (first photoresist layer 30) between two adjacent blue pixel regions (first filling area); The second spacer 70 (auxiliary spacer) is defined on the green photoresist layer (second photoresist layer 40) between two adjacent green pixel regions (second filling area); the third spacer 80 (the auxiliary spacer) is defined on the red photoresist layer (the third photoresist layer 50) between two adjacent red pixel regions (the third filling area). In this condition, the first photoresist layer 30 (blue photoresist layer), the second photoresist layer 40 (green photoresist layer), and the third photoresist layer 50 (red photoresist layer) are all continuous (stripe type), each photoresist layer is a continuous strip shape, and the upper and lower direction is a whole photoresist layer. Further, the surface of the black matrix 20 between two adjacent green pixel areas (second filling area) is defined with a first receiving groove 21, and the surface of the black matrix 20 between two adjacent red pixel areas (third filling area) is defined with a second receiving groove 23. In this condition, the arrangement of the first receiving groove 21 may cause the surface of the second photoresist layer 40 to sink to the same depth as that of the first receiving groove 21, and the second spacer 70 (auxiliary spacer) is defined on the surface of the second photoresist layer 40 accommodated in the first receiving groove 21; The arrangement of the second accommodation groove 23 may make the surface of the third photoresist layer 50 sink to the same depth as that of the second accommodation groove 23, and the third spacer 80 (auxiliary spacer) is defined on the surface of the third photoresist layer 50 that sinks into the second accommodation groove 23.

In this condition, the thickness of the first color resist layer 30 is greater than the thickness of the second color resist layer 40, and the difference in thickness between the two plusing the depth of the first receiving groove 21 may bring about the difference in height between the first spacer 60 and the second spacer 70; In this condition, the thickness of the first color resist layer 30 is greater than the thickness of the third color resist layer 50, and the difference between the thickness of the first color resist layer 30 and the thickness of the third color resist layer 50, plusing the depth of the second receiving groove 23, may bring about the difference in height between the first spacer 60 and the third spacer 80, which may bring about the segment difference between the main spacer and the auxiliary spacer, thereby satisfying the liquid crystal redundancy requirement.

Therefore, it may be understood that the arrangement of the first receiving groove 21 and the second receiving groove 23 may play a role in improving the interval difference between the main spacer and the auxiliary spacer and ensuring liquid crystal redundancy.

Further, in the color filter 100 in some embodiments of of the present disclosure, the first color resist layer 30, the second color resist layer 40, and the third color resist layer 50 are all defined in a strip shape, the first color resist layer 30 includes a first overlapping portion located at one end thereof, the first overlapping portion is located outside the first filling area and overlaps the surface of the black matrix 20 away from the base 10, and the first spacer 60 is located on the surface of the first overlapping portion away from the black matrix 20.

The second photoresist layer 40 includes a second overlapping portion located at one end thereof, the second overlapping portion is located outside the second filling area and partially immersed in the first receiving groove 21, and the second spacer 70 is located on the surface of the second overlapping portion immersed in the first receiving groove 21;

the third photoresist layer 50 includes a third overlapping portion located at one end thereof, the third overlapping portion is located outside the third filling area and partially immersed in the second receiving groove 23, and the third spacer 80 is located on the surface of the third overlapping portion immersed in the second receiving groove 23.

Correspondingly, the first filling area, the second filling area and the third filling area are also defined in strips, and in the two adjacent pixels above and below, the two first filling areas are defined in strips along the vertical direction, and the arrangement of the second filling area and the third filling area is similar to the arrangement of the first filling area, which will not be described in detail here. In this condition, the first photoresist layer 30 (blue photoresist layer), the second photoresist layer 40 (green photoresist layer), and the third photoresist layer 50 (red photoresist layer) are all continuous (stripe type), each photoresist layer is a continuous strip shape, and the upper and lower direction is a whole photoresist layer.

In this way, each photoresist layer may be made to be of a stripe type, and at this time, each photoresist layer may be formed into an entire photoresist layer in the up-down direction at one time, thereby further simplifying the structure and manufacturing process of the color filter 100.

As shown in FIGS. 4 and 5, the thickness of the first photoresist layer 30 is greater than the thickness of the second photoresist layer 40, and the thickness of the first photoresist layer 30 is greater than the thickness of the third photoresist layer 50. In this way, it may improve the segment difference between the main spacer and the auxiliary spacer and ensure liquid crystal redundancy.

Further, the thickness of the second color resist layer 40 is equivalent to that of the third color resist layer 50. In this way, the forming of the second photoresist layer 40 and the forming of the third photoresist layer 50 may realize the multiplexing of certain instruments, devices, instruments, parameters and the like, thereby further simplifying the structure and manufacturing process of the color filter 100.

As shown in FIGS. 5 and 6, the present disclosure also proposes a color filter 100, which includes:

a base 10,

a black matrix 20, defined on one plate surface of the base 10, the black matrix 20 defining a first filling area, a second filling area and a third filling area at intervals; first filling area, a second filling area and a third filling area are defined in a strip shape, the surface of the black matrix 20 adjacent to one end of the second filling area recesses to form a first receiving groove 21, the surface of the black matrix 20 adjacent to one end the third filling area recesses to form a second receiving groove 23,

a color filter layer, including a first photoresist layer 30, a second photoresist layer 40, and a third photoresist layer 50, the first photoresist layer 30, the second photoresist layer 40, and the third photoresist layer 50 are all defined in strips, the first photoresist layer 30 is filled in the first filling area, the second photoresist layer 40 is filled in the second filling area, and the third photoresist layer 50 is filled in the third filling area;

the first color resist layer 30 includes a first overlapping portion at one end thereof, the first overlapping portion being outside the first filling area and overlapping the surface of the black matrix 20 away from the base 10;

the second photoresist layer 40 includes a second overlapping portion at one end thereof, the second overlapping portion being outside the second filling area and partially accommodated in the first receiving groove 21;

the third photoresist layer 50 includes a third overlapping portion at one end thereof, the third overlapping portion being outside the third filling area and partially accommodated in the second receiving groove 23; and

a spacer, including a first spacer 60, a second spacer 70, and a third spacer 80, and the first spacer 60 is defined on the surface of the first overlapping portion away from the black matrix 20; and the second spacer 70 is defined on the surface of the second overlapping portion accommodated in the first receiving groove 21; and the third spacer 80 is defined on the surface of the third overlapping portion accommodated in the second receiving groove 23, the surface of a free end of the first spacer 60 is higher than the surface of a free end of the second spacer 70, the surface of a free end of the first spacer 60 is higher than the surface of a free end of the third spacer 80.

The present disclosure also proposes a liquid crystal panel including an array substrate and a color filter 100 as described above. The specific structure of the color filter 100 refers to the above embodiments. Since this liquid crystal panel adopts all the technical solutions of all the above embodiments, it has at least all the effects brought about by all the technical solutions of all the above embodiments and will not be described here.

The array substrate and the color filter 100 are defined facing to each other, and abut against the first spacer 60.

The present disclosure also proposes a display device including a liquid crystal panel whose specific structure refers to the above-mentioned embodiments. Since the display device adopts all the technical solutions of all the above-mentioned embodiments, it has at least all the effects brought about by all the technical solutions of all the above-mentioned embodiments and will not be described in detail here.

The above is only an alternative embodiment of the present disclosure and is not therefore limiting the scope of the patent disclosure. Any equivalent structural change made by using the contents of the specification and drawings of the present disclosure or directly/indirectly applied in other related technical fields is included in the scope of the patent protection of the present disclosure under the inventive concept of the present disclosure.

What is claimed is:

1. A color filter, comprising:
a base;
a black matrix, defined on one plate surface of the base, the black matrix defining a first filling area, a second filling area and a third filling area at intervals; a color filter layer, comprising a first photoresist layer, a second photoresist layer, and a third photoresist layer, wherein the first photoresist layer is filled in the first filling area, the second photoresist layer is filled in the second filling area, the third photoresist layer is filled in the third filling area, and the edge of the first photoresist layer extends outside the first filling area and overlaps the surface of the black matrix away from the base; and a spacer, comprising a first spacer, a second spacer and a third spacer, wherein the first spacer is defined on the surface of the first photoresist layer overlapping the black matrix, the second spacer and the third spacer are defined above the black matrix, the surface of a free end of the first spacer is higher than the surface of a free end of the second spacer, the surface of a free end of the first spacer is higher than the surface of a free end of the third spacer.

2. The color filter according to claim 1, wherein the second spacer and the third spacer are both defined on the surface of the black matrix away from the base.

3. The color filter according to claim 2, wherein the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix.

4. The color filter according to claim 1, wherein and the edge of the second photoresist layer extends outside the second filling area and overlaps the surface of the black matrix away from the base; the surface of the second photoresist layer overlapping a surface of the black matrix recesses to form a first receiving groove, and the second spacer is defined in the first receiving groove; and the edge of the third photoresist layer extends outside the third filling area and overlaps the surface of the black matrix away from the base; the surface of the third photoresist layer overlapping the black matrix recesses to form a second receiving groove, and the third spacer is defined in the second receiving groove.

5. The color filter according to claim 4, wherein the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix; the second photoresist layer comprises a second overlapping portion located at one end thereof, the second overlapping portion is located outside the second filling area and overlaps the surface of the black matrix away from the base, the surface of the second overlapping portion away from the black matrix recesses to form a first receiving groove, the third photoresist layer comprises a third overlapping portion located at one end thereof, the third overlapping portion is located outside the third filling area and overlaps the surface of the black matrix away from the base, the surface of the third overlapping portion away from the black matrix recesses to form a second receiving groove.

6. The color filter according to claim 1, wherein the surface of the black matrix adjacent to the second filling area recesses to form a first receiving groove, the edge of the second photoresist layer extends toward the first receiving groove and is at least partially accommodated in the first receiving groove, and the second spacer is defined on the surface of the second photoresist layer accommodated in the first receiving groove; the surface of the black matrix adjacent to the third filling area recesses to form a second receiving groove, the edge of the third photoresist layer extends toward the second receiving groove and is at least partially accommodated in the second receiving groove, and the third spacer is defined on the surface of the third photoresist layer accommodated in the second receiving groove.

7. The color filter according to claim 6, wherein the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix; the second photoresist layer comprises a second overlapping portion located at one end thereof, the second overlapping portion is defined outside the second filling area and partially accommodated in the first receiving groove, and the second spacer is defined on the surface of the second overlapping portion accommodated in the first receiving groove; the third photoresist layer comprises a third overlapping portion located at one end thereof, the third overlapping portion is defined outside the third filling area and partially accommodated in the second receiving groove, and the third spacer is defined on the surface of the third overlapping portion accommodated in the second receiving groove.

8. The color filter according to claim 1, wherein the thickness of the first photoresist layer is greater than the thickness of the second photoresist layer, the thickness of the first photoresist layer is greater than the thickness of the third photoresist layer, the thickness of the second photoresist layer is equal to the thickness of the third photoresist layer.

9. The color filter according to claim 1, wherein the first photoresist layer, the second photoresist layer and the third photoresist layer are respectively a blue photoresist layer, a green photoresist layer, and a red photoresist layer.

10. A color filter, comprising:
a base;
a black matrix, defined on one plate surface of the base, the black matrix defining a first filling area, a second filling area and a third filling area at intervals; first filling area, a second filling area and a third filling area are defined in a strip shape, the surface of the black matrix adjacent to one end of the second filling area recesses to form a first receiving groove, the surface of the black matrix adjacent to one end the third filling area recesses to form a second receiving groove, a color filter layer, comprising a first photoresist layer, a second photoresist layer, and a third photoresist layer, the first photoresist layer, the second photoresist layer, and the third photoresist layer are all defined in a strip shape, the first photoresist layer is filled in the first filling area, the second photoresist layer is filled in the second filling area, the third photoresist layer is filled in the third filling area, the first photoresist layer comprises a first overlapping portion located at one end thereof, the first overlapping portion is located outside the first filling area and overlaps the surface of the black matrix away from the base, the second photoresist layer comprises a second overlapping portion located at one end thereof, the second overlapping portion is defined outside the second filling area and partially accommodated in the first receiving groove, the third photoresist layer comprises a third overlapping portion located at one end thereof, the third overlapping portion is defined outside the third filling area and partially accommodated in the second receiving groove, and a spacer, comprising a first spacer, a second spacer and a third spacer, and the first spacer is defined on the surface of the first overlapping portion away from the black matrix; and the second spacer is defined on the surface of the second overlapping portion accommodated in the first receiving groove; and the third spacer is defined on the surface of the third overlapping portion accommodated in the second receiving groove, the surface of a free end of the first spacer is higher than the surface of a free end of the second spacer, the surface of a free end of the first spacer is higher than the surface of a free end of the third spacer.

11. The color filter according to claim 10, wherein the first photoresist layer, the second photoresist layer and the third photoresist layer are respectively a blue photoresist layer, a green photoresist layer, and a red photoresist layer.

12. A liquid crystal panel, comprising an array substrate and a color filter, the color filter comprising: a base; a black matrix, defined on one plate surface of the base, the black matrix defining a first filling area, a second filling area and a third filling area at intervals; a color filter layer, comprising a first photoresist layer, a second photoresist layer, and a third photoresist layer, the first photoresist layer is filled in the first filling area, the second photoresist layer is filled in the second filling area, the third photoresist layer is filled in the third filling area, and the edge of the first photoresist layer extends outside the first filling area and overlaps the surface of the black matrix away from the base; and a spacer, comprising a first spacer, a second spacer and a third spacer, wherein the first spacer is defined on the surface of the first photoresist layer overlapping the black matrix, the second spacer and the third spacer are defined above the black matrix, the surface of a free end of the first spacer is higher than the surface of a free end of the second spacer, the surface of a free end of the first spacer is higher than the surface of a free end of the third spacer; the array substrate and the color filter are defined facing to each other, and abut against the first spacer.

13. The liquid crystal panel according to claim 12, wherein the second spacer and the third spacer are both defined on the surface of the black matrix away from the base.

14. The display panel according to claim 13, wherein the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix.

15. The display panel according to claim 12, wherein and the edge of the second photoresist layer extends outside the second filling area and overlaps the surface of the black matrix away from the base; the surface of the second photoresist layer overlapping a surface of the black matrix recesses to form a first receiving groove, and the second spacer is defined in the first receiving groove; and the edge of the third photoresist layer extends outside the third filling area and overlaps the surface of the black matrix away from the base; the surface of the third photoresist layer overlapping the black matrix recesses to form a second receiving groove, and the third spacer is defined in the second receiving groove.

16. The display panel according to claim 15, wherein the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix; the second photoresist layer comprises a second overlapping portion located at one end thereof, the second overlapping portion is located outside the second filling area and overlaps the surface of the black matrix away from the base, the surface of the second overlapping portion away from the black matrix recesses to form a first receiving groove, the third photoresist layer comprises a third overlapping portion located at one end thereof, the third overlapping portion is located outside the third filling area and overlaps the surface of the black matrix away from the base, the surface of the third overlapping portion away from the black matrix recesses to form a second receiving groove.

17. The display panel according to claim 12, wherein the surface of the black matrix adjacent to the second filling area recesses to form a first receiving groove, the edge of the second photoresist layer extends toward the first receiving groove and is at least partially accommodated in the first receiving groove, and the second spacer is defined on the surface of the second photoresist layer accommodated in the first receiving groove; the surface of the black matrix adjacent to the third filling area recesses to form a second receiving groove, the edge of the third photoresist layer extends toward the second receiving groove and is at least partially accommodated in the second receiving groove, and the third spacer is defined on the surface of the third photoresist layer accommodated in the second receiving groove.

18. The display panel according to claim 17, wherein the first photoresist layer, the second photoresist layer, and the third photoresist layer are all defined in a strip shape, the first photoresist layer comprises a first overlapping portion located at one end thereof, the first overlapping portion is located outside the first filling area and overlaps the surface of the black matrix away from the base, and the first spacer is defined on the surface of the first overlapping portion away from the black matrix; the second photoresist layer comprises a second overlapping portion located at one end thereof, the second overlapping portion is defined outside the second filling area and partially accommodated in the first receiving groove, and the second spacer is defined on the surface of the second overlapping portion accommodated in the first receiving groove; the third photoresist layer comprises a third overlapping portion located at one end thereof, the third overlapping portion is defined outside the third filling area and partially accommodated in the second receiving groove, and the third spacer is defined on the surface of the third overlapping portion accommodated in the second receiving groove.

19. The display panel according to claim 12, wherein the thickness of the first photoresist layer is greater than the thickness of the second photoresist layer, the thickness of the first photoresist layer is greater than the thickness of the third photoresist layer, the thickness of the second photoresist layer is equal to the thickness of the third photoresist layer.

20. The display panel according to claim 12, wherein the first photoresist layer, the second photoresist layer and the third photoresist layer are respectively a blue photoresist layer, a green photoresist layer, and a red photoresist layer.
